(19) United States
(12) Patent Application Publication
(10) Pub. No.: US 2008/0199235 A1
(43) Pub. Date: Aug. 21, 2008

(54) Method of producing a double-sided printed material and double-sided printing apparatus

(76) Inventors: Noriyoshi Shoji, Chiba-shi (JP); Norimitsu Sanbongi, Chiba-shi (JP); Takanori Okayasu, Chiba-shi (JP); Kazuo Tani, Chiba-shi (JP); Yoshinori Sato, Chiba-shi (JP)

Correspondence Address: BRUCE L. ADAMS, ESQ;ADAMS & WILKS, 17 BATTERY PLACE - SUITE 1231, NEW YORK, NY, 10004, US

(21) Appl. No.: 12/011,381

(22) Filed: Jan. 24, 2008

(30) Foreign Application Priority Data
Feb. 5, 2007 (JP) 2007-025635

(51) Int. Cl. G03G 15/00

(52) U.S. Cl. 399/364

(57) ABSTRACT

When first print information is input, a print length thereof is calculated so as to calculate a length of a double-sided printed material 1 to be finally produced. Then, print information blocks 2 to be printed on a back surface of the recording medium is selected. The print information blocks 2 are selected according to a priority thereof, and a single print information block 2 to be selected last is selected, based on the length of the double-sided printed material, so that all the margins have the same length within a predetermined allowable range when the selected print information blocks 2 are sequentially arranged to be printed on the back surface. After the second print information is thus determined, the first print information is printed on the front surface of the recording medium and is cut by a cutter unit, and then the second print information is printed on the back surface thereof.

### BACKGROUND OF THE INVENTION

1. Field of the Invention

The present invention relates to a method of producing a double-sided printed material and a double-sided printing apparatus. In particular, the present invention relates to a method of producing a double-sided printed material of a single cut sheet, and a double-sided printing apparatus, for printing first print information on one surface of a recording medium in a continuous form, cutting a portion of the recording medium, on which the first print information is printed, and printing second print information on the other surface of the recording medium.

2. Description of the Related Art

Patent Document 1 discloses a double-sided printing apparatus for producing a double-sided printed material of a single cut sheet by performing printing on both surfaces of a recording medium in a continuous form. In the apparatus, the recording medium in a continuous form is subsequently fed from a roll, and printing is performed on one surface thereof by using a first printing mechanism. After that, a portion of the recording medium, which is printed by the first printing mechanism, is cut into single cut sheets with a cutter, and then printing is performed on the other surface of the recording medium of the single cut sheet by a second printing mechanism. In the double-sided printing apparatus, the same type of print information is not always printed on both surface of the recording medium, but information to be printed on one surface of the recording medium may be different from information to be printed on the other surface thereof.

For example, contents input for each case are printed on one surface (front surface) of the recording medium, and print information prepared in advance is printed on the other surface (back surface) thereof. Specifically, it is possible that the double-sided printing apparatus is applied to a cash register in which purchased items, unit prices thereof, a total price, and the like are printed on the front surface of the recording medium, and an advertisement, a coupon, and information for a consumer are printed on the back surface thereof. Then, the recording medium is cut at a position where an appropriate margin is added to a print end point of the print information (purchased items, unit price thereof, a total price, and the like) printed on the front surface, thereby producing a receipt (double-sided printed material) of a single cut sheet to be handed over to the consumer.
[Patent Document 1] JP 06-262785 A

In a case where the contents to be printed on the front surface are changed for each case, for example, when the double-sided printing apparatus as disclosed in Patent Document 1 is applied to a cash register, there is a possibility that a length of a printed material of a single cut sheet which is finally produced is changed for each case. In this case, it is possible that the length of the printed material does not match a size of print information to be printed on the back surface. For example, even when necessary print information is printed on the front surface not shown in an appropriate layout, there is a possibility that print information 30 such as an advertisement prepared in advance is printed on the back surface in an awkward layout as shown in FIGS. 10A and 10B. In other words, in an example shown in FIG. 10A, an extremely wide space is produced on a rear side of the print information 30 such as the advertisement printed on the back surface, and in an example shown in FIG. 10B, the print information 30 such as the advertisement printed on the back surface is cut halfway therethrough.

When the print information to be printed on the back surface is assumed as a block, that is, a so-called print information block 30a, the print information block 30a such as the advertisement is repeatedly printed on the back surface of the recording medium. As a result, it is possible to use the entire back surface of the single cut sheet without waste. However, even by merely repeatedly printing the print information block 30a without interruption, there is a fear that, on the back surface of the completed printed material of a single cut sheet, the printing may be started halfway through the print information block 30a and may end halfway through the print information block 30a, as shown in FIG. 11A. As shown in FIGS. 11B and 11C, a print start point of the print information block 30a printed on the back surface is aligned with a leading edge of the recording medium of a single cut sheet, thereby making it possible to print the print information block 30a from an appropriate position on the back surface of the printed material. However, also in this case, there is a fear that the print information block 30a is cut halfway therethrough, or that a wide space is produced on the rear side of the print end point of the print information block 30a.

Incidentally, instead of repeatedly printing a single print information block 30a on the back surface of the recording medium, it is possible that a plurality of print information blocks 30a are stored in advance, and different print information blocks are sequentially arranged to be printed. In this case, in the same manner as shown in FIGS. 11A and 11B, in the case where the print information block 30a is printed halfway therethrough, or in the case where the printing of the print information block 30a is stopped halfway therethrough, the whole contents of the print information block 30a cannot be displayed. As a result, a necessary function as a display cannot be achieved.

### SUMMARY OF THE INVENTION

Therefore, an object of the present invention is to provide a method of producing a double-sided printed material and a double-sided printing apparatus capable of, in a case of producing a printed material of a single cut sheet obtained by cutting a recording medium in a continuous form according to a print range of a first print information printed on one surface thereof, printing second print information on the other surface thereof in an appropriate layout.

A feature of the present invention resides in that a method of producing a double-sided printed material of a single cut sheet includes the steps of: printing first print information on one surface of a recording medium in a continuous form; cutting a portion of the recording medium, on which the first print information is printed; and printing second print information on the other surface of the recording medium, the method being characterized in that: the first print information includes information which may have a different print length for each double-sided printed material; the second print information includes one or a plurality of print information blocks selected from among a plurality of print information blocks which are independent of each other and are stored in a memory unit in advance; the print information blocks each include, as data, a print length required when the print information blocks are each printed on the recording medium, and priorities of information contents, and are compiled as a database and stored; the method further includes the step of selecting, by a central processing unit, the print information blocks constituting the second print information before printing is performed on the other surface of the recording medium; and the step of selecting the print information blocks includes: selecting the print information blocks according to the priorities thereof; and selecting, by the central processing unit, one of the print information blocks in such a manner that a print length of the first print information is obtained, a length of the double-sided printed material is obtained based on the print length, and a plurality of margins provided on the other surface are evenly dispersed based on the obtained print length of the double-sided printed material so as to be set within an allowable range determined in advance.

With the structure, for example, in a case of printing a plurality of print information blocks, the print information blocks excluding a single print information block are selected according to priorities determined in advance. The single print information block is selected in such a manner that all the margins on the surface are evenly dispersed in an appropriate size. As a result, the margins with the appropriate size are provided between the respective print information blocks, and an extremely easy-to-read double-sided printed material can be produced without cutting the print information block halfway therethrough. As a matter of course, also in a case of printing a single print information block, margins with an appropriate size are provided between the respective print information blocks, and an easy-to-read double-sided printed material can be obtained without cutting the print information block halfway therethrough.

The step of selecting the print information blocks, which is performed by the central processing unit, may include: repeatedly selecting the print information blocks in an order of higher priority among non-selected print information blocks; judging whether the selected print information blocks can be arranged on the double-sided printed material, and canceling selection of one of the print information blocks when it is judged that the selected print information blocks cannot be arranged therein; judging whether lengths of margins evenly dispersed are set within the allowable range in a case where margins in a direction of the print length, which are produced when the print information blocks that are left without canceling selection thereof are arranged within the double-sided printed material, are evenly dispersed on front and rear sides of the print information blocks; and replacing one of the print information blocks, which are left without canceling selection thereof, with the print information block having a print length different from that of the one of the print information blocks, when it is judged that the length of the margins is not set within the allowable range.

In this case, the method may further include: replacing a single print information block selected last among the print information blocks, which are left without canceling selection thereof, with the print information block having a print length shorter than that of the last selected print information block, when it is judged that the length of the margins is smaller than a minimum value of the allowable range; and replacing a single print information block selected last among the print information blocks, which are left without canceling selection thereof, with the print information block having a print length longer than that of the last selected print information block, when it is judged that the length of the margins is larger than a maximum value of the allowable range.

Alternatively, the step of selecting the print information block, which is performed by the central processing unit, may include: selecting the print information blocks in an order of higher priority among non-selected print information blocks; judging whether a length of each of margins evenly dispersed can be set within the allowable range, in a case where the margins in a direction of the print length, which are produced when the selected print information blocks are arranged within the double-sided printed material, are evenly dispersed on front and read sides of the print information blocks; when it is judged that the length of the margins cannot be set within the allowable range, replacing one of the selected print information blocks with the print information block having a print length different from that of the one of the selected information blocks, or additionally selecting any one of the non-selected print information blocks.

In this case, the method may further include: when it is judged that the length of the margins is smaller than a minimum value of the allowable range, replacing one of the selected print information blocks with the print information block having a print length shorter than that of the one of the selected print information blocks; and when it is judged that the length of the margins is larger than a maximum value of the allowable range, additionally selecting any one of the non-selected print information blocks.

The method may further include: when it is judged that the length of the margins cannot be set within the allowable range, repeatedly performing replacement of one of the selected print information blocks with the print information block having the print length different from that of the one of the selected print information block, or additional selection of any one of the non-selected print information blocks; and when it is judged that the length of the margins can be set within the allowable range, when judgment whether or not the margin can be set within the allowable range is completed with respect to all the stored print information blocks, or when the number of times of repeating the replacement of the print information block or the additional selection reaches a predetermined number of times, repetition of the replacement of the print information block or the additional selection is finished. As a result, when there is only a small variation of print lengths of the print information blocks, or when the allowable range of the margin is narrower, it is possible to deal with the case where the appropriate layout cannot be easily found.

The print information blocks each may have a parameter of a selection condition in addition to the print length and the priority, the parameter may indicate a type of information of each of the print information blocks, and the print information blocks of different types from each other may be preferentially selected in a case of selecting a plurality of the print information blocks. In this case, for example, based on the attributes such as the advertisement, the coupon, and the information for the consumer, the print information blocks can be selected uniformly.

The print information blocks each may have a parameter of a selection condition in addition to the print length and the priority, and the print information blocks may be selected only when the selection condition is satisfied. For example, the selection conditions may include at least one of the gender of a counterpart to whom the double-sided printed material is handed over, a time at which the double-sided printed material is handed over, an area in which the double-sided printed material is handed over, a weather condition under which the double-sided printed material is handed over, and a condition whether another print information block can be additionally printed or not. As a result, the selection of the print information blocks can be precisely controlled based on the contents of the respective pieces of information.

Another feature of the present invention is in that a method of producing a double-sided printed material of a single cut sheet includes the steps of: printing first print information on one surface of a recording medium in a continuous form; cutting a portion of the recording medium, on which the first print information is printed; and printing second print information on the other surface of the recording medium, the method being characterized in that: the first print information includes information which may have a different print length for each double-sided printed material; the second print information includes one or a plurality of print information blocks selected from among a plurality of print information blocks which are independent of each other and are stored in a memory unit in advance; the print information blocks include: a plurality of main blocks, each of which includes, as data, a print length required when the print information blocks are each printed on the recording medium, and priorities of information contents, and which are compiled as a database and stored in the memory unit; and a plurality of margin adjusting blocks, each of which includes, as data, the print length required when the print information blocks are printed on the recording medium, and which are stored in the memory unit as another database separate from the main blocks; the another database stores the plurality of margin adjusting blocks having different print lengths including print information blocks having the print length shorter than that of the main blocks; the method further includes the step of selecting, by a central processing unit, the print information blocks constituting the second print information before printing is performed on the other surface of the recording medium; and the step of selecting the print information blocks includes: selecting at least one of the margin adjusting blocks; selecting one or a plurality of the main blocks as well as the at least one of the margin adjusting blocks according to the priorities; and selecting, by the central processing unit, the at least one of the margin adjusting blocks based on the print length in such a manner that a print length of the first print information is obtained, a length of the double-sided printed material is obtained based on the print length, and a plurality of margins provided on the other surface are evenly dispersed based on the obtained length of the double-sided printed material so as to be set within an allowable range determined in advance.

Still another feature of the present invention is in that a method of producing a double-sided printed material of a single cut sheet includes the steps of: printing first print information on one surface of a recording medium in a continuous form; cutting a portion of the recording medium, on which the first print information is printed; and printing second print information on the other surface of the recording medium, the method being characterized in that: the first print information includes information which may have a different print length for each double-sided printed material; the second print information includes one or a plurality of print information blocks selected from among a plurality of print information blocks which are independent of each other and are stored in a memory unit in advance; the print information blocks each include, as data, a print length required when the print information blocks are each printed on the recording medium, and priorities of information contents, and are compiled as a database and stored; the print information blocks are given the priorities different from each other, in a case where a plurality of the print information blocks having the same print length are stored in the memory unit; the method further includes the step of selecting, by a central processing unit, the print information blocks constituting the second print information before printing is performed on the other surface of the recording medium; and the step of selecting the print information blocks includes determining, by the central processing unit, the print length of one or a plurality of the print information blocks to be selected, in such a manner that a print length of the first print information is obtained, a length of the double-sided printed material is obtained based on the print length, and a plurality of margins provided on the other surface are evenly dispersed based on the obtained length of the double-sided printed material so as to be set within an allowable range determined in advance, to thereby select the print information blocks with higher priority among the print information blocks having the determined print length.

Yet another feature of the present invention is in that a double-sided printing apparatus includes: a first unit for printing first print information on one surface of a recording medium in a continuous form; a cutter unit for cutting a portion of the recording medium, on which the first print information is printed; and a second recording unit for printing second print information on the other surface of the recording medium, the apparatus being characterized in that: the first print information includes information which may have a different print length for each double-sided printed material; the second print information includes one or a plurality of print information blocks selected from among a plurality of print information blocks which are independent of each other and are stored in a memory unit in advance; the apparatus further includes: a memory unit for causing the print information blocks each to hold, as data, a print length required when the print information blocks are each printed on the recording medium, and priorities of information contents, so as to be compiled as a database and stored; and a central processing unit for selecting the print information blocks constituting the second print information before printing is performed on the other surface of the recording medium, the central processing unit selecting the print information blocks according to the priorities thereof, and selecting one of the print information blocks in such a manner that a print length of the first print information is obtained, a length of the double-sided printed material is obtained based on the print length, and a plurality of margins provided on the other surface are evenly dispersed based on the obtained print length of the double-sided printed material so as to be set within an allowable range determined in advance.

According to the present invention, in a case of cutting a recording medium based on the first print information to be printed on one surface of the recording medium to produce a double-sided printed material, appropriate margins are provided on the other surface thereof, thereby making it possible to print information blocks in an easy-to-read layout.

### BRIEF DESCRIPTION OF THE DRAWINGS

In the accompanying drawings:

FIG. 1A is a schematic diagram showing one surface of a double-sided printed material produced according to the present invention, and FIG. 1B is a schematic diagram showing the other surface thereof;

FIG. 2 is a block diagram showing a main part of a double-sided printing apparatus used in a method of producing a double-sided printed material according to the present invention;

FIG. 3 is a table showing an example of data stored in a memory unit of the double-sided printing apparatus shown in FIG. 2;

FIG. 4 is a flowchart showing a method of producing a double-sided printed material according to a first embodiment of the present invention;

FIG. 5 is a flowchart showing a main part of a method of producing a double-sided printed material according to a second embodiment of the present invention;

FIG. 6 is a table showing an example of data stored in a memory unit of a double-sided printing apparatus according to a third embodiment of the present invention;

FIG. 7 is a flowchart showing a main part of a method of producing a double-sided printed material according to a fourth embodiment of the present invention;

FIG. 8 is a flowchart showing a main part of a method of producing a double-sided printed material according to a fifth embodiment of the present invention;

FIG. 9 is a schematic diagram showing an internal mechanism of the double-sided printing apparatus used in the method of producing the double-sided printed material according to the present invention;

FIGS. 10A and 10B are schematic diagrams each showing an example of a double-sided printed material produced by a conventional method; and

FIGS. 11A-11C are schematic diagrams each showing an example of the double-sided printed material produced by the conventional method.

### DETAILED DESCRIPTION OF THE PREFERRED EMBODIMENT

Hereinafter, embodiments of the present invention will be described with reference to the drawings.

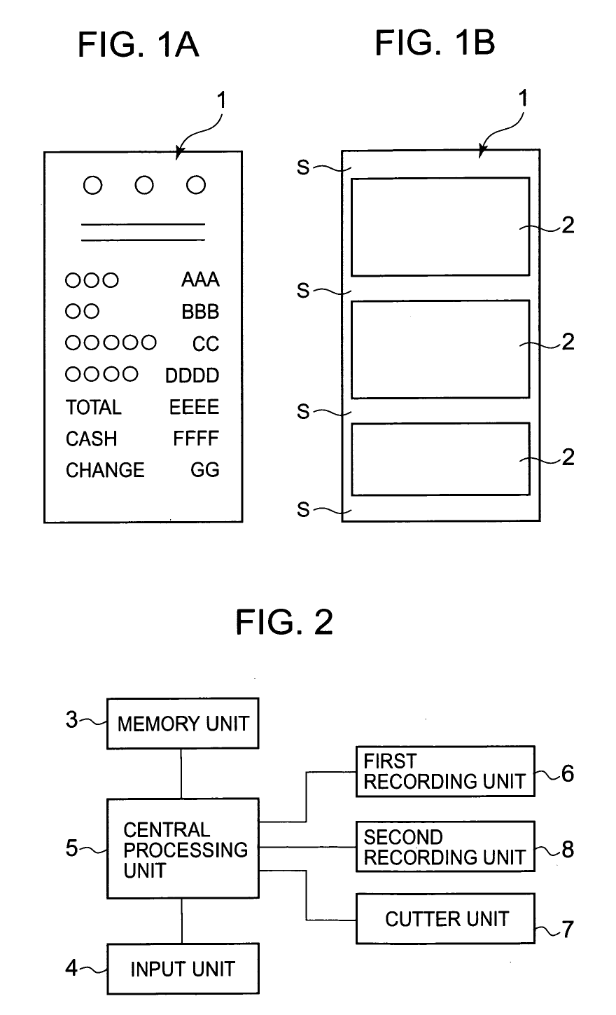

First, description is given of a method of producing a double-sided printed material according to an embodiment of the present invention with reference to FIGS. 1 to 8. In this embodiment, an example in which the present invention is applied to a cash register is illustrated, and a double-sided printing apparatus is built in the cash register so as to produce a so-called receipt as the double-sided printed material. Thus, as shown in FIG. 1A, in the receipt which is an example of a double-sided printed material 1 produced according to the present invention, items purchased by a consumer, unit prices thereof, a total price, and the like, as first print information, are printed on one surface (front surface) of the printed material 1. Further, as shown in FIG. 1B, a plurality of print information blocks 2, as second print information, are arranged in a longitudinal direction of the double-sided printed material 1 to be printed on the other surface (back surface) thereof. According to this embodiment, a layout of the print information blocks 2 on the back surface of the double-sided printed material 1 is determined such that margins S between the print information blocks are each provided with an appropriate size.

Note that the print information block 2 of this case refers to separate individual pieces of data for each content of various advertisements and the like. For example, in a case where an advertisement for a single product includes several lines of texts and several images, the texts and images are assumed as a single print information block 2, which can be handled independently of the texts, the images, and the like regarding another product. Note that the entire print information blocks are each denoted by reference numeral 2 in the specification of the present invention. However, in a case of describing the respective print information blocks to be distinguished from one another, each of the print information blocks are denoted by reference symbols 2A, 2B, 2C, 2D . . . .

### First Embodiment

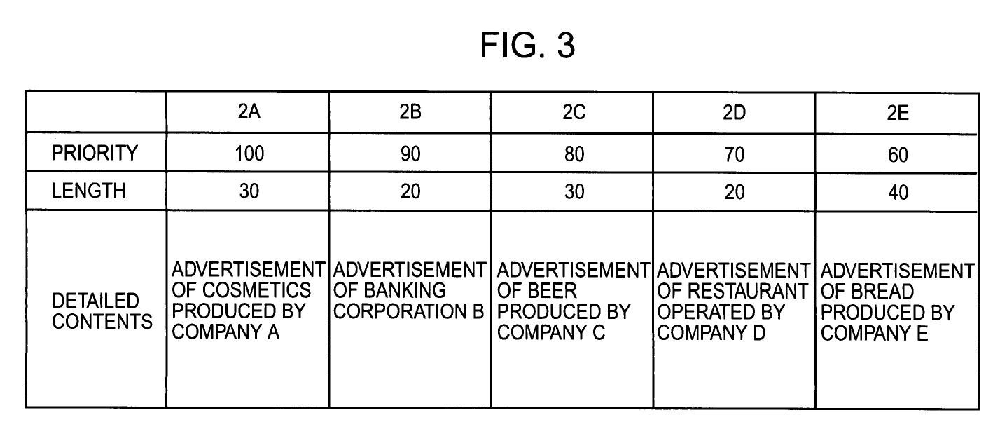

In a stage of preparation for producing the double-sided printed material 1 in this embodiment, a plurality of print information blocks 2 are stored in a memory unit 3 (see FIG. 2). In this case, as shown in FIG. 3, for each print information block 2, data indicating contents of the print information block 2, a print length required for printing the print information block on the recording medium, and priorities of the contents are each held as data to be compiled as a database and stored. The priorities are obtained by converting degrees, at which the printing on the double-sided printed material 1 is desired, into numerical values or ranking the degrees, when the print information blocks 2 are compared with one another. For example, the priorities may be determined based on an advertising rate (contract rate) of a sponsor and the like.

The first print information to be printed on one surface (front surface) of the double-sided printed material 1 is input from an input unit 4, thereby starting production of the double-sided printed material 1 (Step S1). Step S1 is executed through, for example, an operation of a keyboard (input unit 4) of the cash register by an operator, or reading of a barcode with a barcode reader (input unit 4).

Then, a central processing unit 5 confirms the input first print information, calculates the print length required for printing the first print information on the recording medium, and presets margins to be provided on front and rear sides thereof in addition to the print length, thereby calculating a length L1 of the double-sided printed material 1 to be finally produced (Step S2).

Next, based on the calculated length L1 of the double-sided printed material, the central processing unit 5 selects the print information blocks 2 to be printed on the back surface of the recording medium, and determines the second print information (Step S3). At this time, as shown in FIG. 1B, when the selected print information blocks 2 are sequentially arranged to be printed on the back surface of the double-sided printed material 1 finally produced, the print information blocks 2 are selected in such a manner that a margin S formed on the front side (leading edge side of recording medium) of a forward-most print information block 2, margins S formed between each of the print information blocks 2, and a margin S formed on the rear side (trailing edge side of recording medium) of a last print information block 2 each have the same length, and each length thereof can be set within a predetermined allowable range. Note that when only a single information block 2 is selected, the lengths of the margins S formed on the front and rear sides of the print information block 2 are set within the predetermined allowable range.

A specific example of Step S3 will be described in detail. First, a highest-priority print information block 2 (for example, 2A) is selected among the plurality of print information blocks 2 stored in the memory unit 3 (Step S3a). Subsequently, a highest-priority print information block 2 among non-selected print information blocks 2, that is, a second-highest priority print information block 2 (for example, 2B) next to the print information block already selected is additionally selected (Step S3b). Then, a total print length L2 of the print information blocks 2 (for example, 2A+2B) selected by that time is obtained, and the obtained total print length L2 is compared with the length L1 of the double-sided printed material (Step S3c).

In this case, when the total length L2 of the print lengths of the selected print information blocks 2 (2A+2B) is longer than the length L1 of the double-sided printed material, that is, when the selected print information blocks 2 fall within the double-sided printed material 1, Steps S3b to S3c are repeated. Specifically, a second-highest priority print information block 2 (for example, 2C) next to the print information blocks 2 (2A and 2B) already selected is additionally selected, the total length L2 of the print lengths of the selected print information blocks 2 (2A+2B+2C) is calculated, and the calculated total length L is compared with the length L1 of the double-sided printed material. In this manner, a process of additionally selecting the print information blocks 2 in the order of higher priority is repeated until the total length L2 of the print lengths of the selected print information blocks 2 becomes shorter than the length L1 of the double-sided printed material, that is, until the selected print information block 2 cannot fall within the double-sided printed material 1.

In Step S3c, when it is judged that the total length L2 of the print lengths of the selected print information blocks 2 (2A+2B+2C) is shorter than the length L1 of the double-sided printed material, all the selected print information blocks 2 (2A, 2B, and 2C) cannot fall within the double-sided printed material 1, so the selection of a single print information block 2 (2C) last selected in the preceding step S3c is cancelled (Step S3d).

At this point of time, all the selected print information blocks 2 (2A and 2B) can be printed. However, there is a fear that the margins produced between the print information blocks 2 become extremely long or extremely short, with the result that the print information blocks 2 are hardly viewed or appearance thereof is deteriorated. Accordingly, control for setting the margins to have an appropriate length is subsequently performed.

In this case, excluding the print information block 2 (2C), whose selection is cancelled in Step S3d, the length L2 of the print information blocks 2 (2A+2B), which are left without canceling the selection thereof, is subtracted from the length L1 of the double-sided printed material, which is obtained in Step S2, thereby obtaining lengths of margins provided on the entire recording medium in the longitudinal direction thereof. Then, a length L3 of each margin produced in a case where the margins are evenly dispersed on the front and rear sides of the print information blocks 2 (2A and 2B) is calculated (Step S3e). It is judged whether the length L3 of the margin can be set within the preset allowable range (Step S3f). At this time, when it is judged that the length L3 of the margin can be set within the allowable range, the print information blocks 2 (2A and 2B) already selected at that time are determined as the second print information, thereby ending the selection of the print information blocks 2 (Step S3g).

When it is judged that the length L3 of the margin is out of the allowable range, the last selected print information block 2 (2B) of the print information blocks 2 (2A and 2B) is replaced with any one of non-selected print information blocks 2 (Step S3h). In this case, when the length L3 of the margin is smaller than a minimum value of the allowable range, the print information block 2 (2B) is replaced with a print information block (for example, 2D) having a shorter print length. When the length L3 of the margin is larger than a maximum value of the allowable range, the print information block 2 is replaced with a print information block (for example, 2E) having a longer print length. If a plurality of print information blocks having the same print length exist in the non-selected print information blocks, a print information block with higher priority there among is selected.

Then, Steps S3e to S3f described above are repeated, and when it is judged that the length L3 of the margin can be set within the allowable range, the print information blocks 2 (2A and 2D) are determined as the second print information, thereby ending the selection of the second print information block 2 (Step S3g). However, in Step S3f repeatedly performed, when it is judged that the length of the margin is still out of the allowable range, the replacement of another print information block 2 (Step S3h), the calculation of the length L3 of the margin (Step S3e), and the comparison with the allowable range and judgment thereof (Step S3f) are repeatedly performed until it is judged that the length L3 of the margin can be set within the allowable range.

Thus, when the selection of the print information blocks 2 is completed in Step S3 and when the second print information to be printed on the back surface is determined, a first recording unit 6 performs printing of first recorded information, that is, items purchased by a consumer, unit prices thereof, a total price, and the like in the example as shown in FIG. 1A, on the front surface of the recording medium in a continuous form (Step S4).

A cutter unit 7 cuts the recording medium in the continuous form from a print end position of the first recorded information to a position at which a small and appropriate margin is provided, thereby obtaining single cut sheets (Step S5).

Then, a second recording unit 8 performs printing of the second print information, that is, the print information blocks 2 such as an advertisement determined in Step S3g in the example as shown in FIG. 1B, on the back surface of the recording medium of a single cut sheet (Step S6). At this time, the layout of the print information blocks 2 is performed so as to obtain the length L3 which is determined such that all the margins provided between the print information blocks 2 are obtained in Step S3e and it is confirmed that the margins are set within the allowable range in Step S3h.

Finally, the double-sided printed material 1, both surfaces of which have been printed, is ejected to an outside (Step S7). In the case where the double-sided printed material is a receipt, the double-sided printed material is handed over to a consumer.

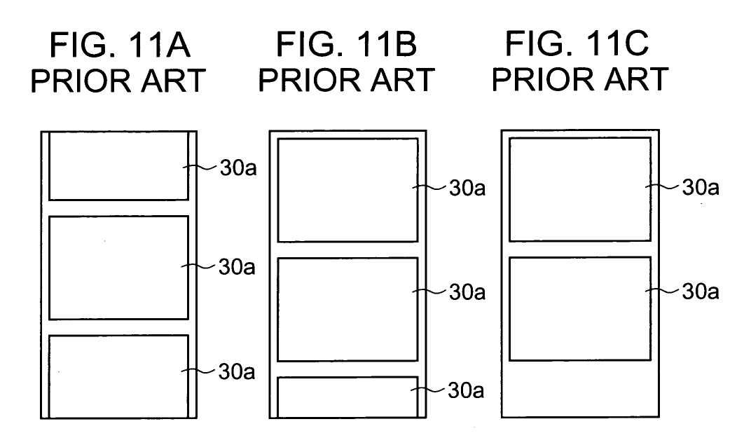

It is possible that the double-sided printed material 1 varies for each case, because an amount of the first-print information to be printed on the front surface is changed when the number of items to be purchased is changed, for example, and the length of the double-sided printed material 1 is not constant. However, in the present invention, a single or a plurality of appropriate print information blocks 2 are selected, thereby printing the print information blocks 2 laid out with appropriate margins on the back surface. Accordingly, the print information blocks are prevented from being printed halfway therethrough, and from being cut halfway therethrough (see FIGS. 10 and 11) unlike the conventional case. Further, the margins are prevented from being set to be extremely long or extremely short. As a result, the easy-to-read double-sided printed material 1 can be produced. In addition, the print information blocks other than a single print information block selected last are arranged in the order of higher priority. Accordingly, it is possible to achieve an effect of selecting the print information blocks by automatically taking a priority parameter into consideration, which is incompatible with a setting of the appropriate layout in the conventional case.

Note that the cutting by the cutter unit 7 (Step S5) and the printing on the other surface of the recording medium by the second recording unit 8 (Step S6) may be sequentially replaced with each other. In addition, the printing of the first print information (Step S4) and the selection of the print information block 2 (Step S3) may be sequentially replaced with each other.

### Second Embodiment

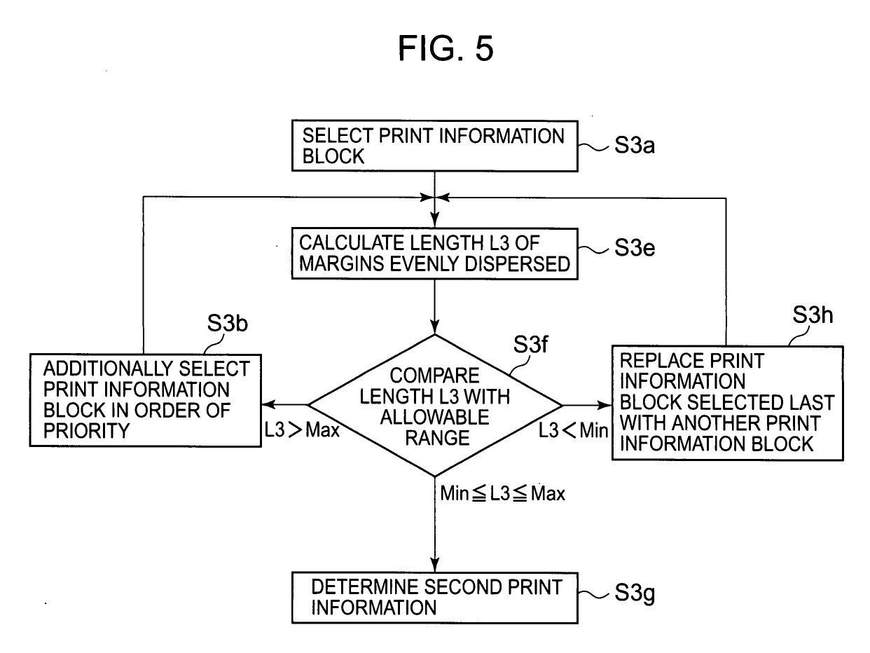

Next, description is given of a method of producing a double-sided printed material according to a second embodiment of the present invention. The method of this embodiment is different from that of the first embodiment only in a step of selecting the print information blocks 2 to be printed on the back surface of the recording medium by the central processing unit 5. Accordingly, only Step S3 will be described with reference to FIG. 5. Note that steps having contents substantially the same as those of the steps of the first embodiment are denoted by the same reference symbols.

In this embodiment, first, a highest-priority print information block 2 (for example, 2A) is selected from among a plurality of print information blocks 2 stored in the memory unit 3 (Step S3a). Subsequently, the length of the print information block 2 (2A) selected at that time is subtracted from the length L1 of the double-sided printed material, which is obtained in Step S2, thereby obtaining lengths of margins provided on the entire recording medium in the longitudinal direction thereof. Then, the length L3 of each margin produced in a case where the margins are evenly dispersed on the front and rear sides of the print information block 2 (2A) is calculated (Step S3e). It is judged whether the length L3 of the margin can be set within the preset allowable range (Step S3f). At this time, when it is judged that the length L3 of the margin can be set within the allowable range, the print information block 2 (2A) already selected at that time is determined as the second print information, thereby ending the selection of the print information blocks 2 (Step S3g).
In Step S3f, when it is judged that the length L3 of the margin is larger than a maximum value Max of the allowable range, a highest-priority print information block 2 among non-selected print information blocks 2, that is, a second-highest priority print information block 2 (for example, 2B) next to the print information block (2A) already selected is additionally selected (Step S3b). Then, Steps S3e to S3f are repeated. Specifically, the total length of the print lengths of the selected print information blocks 2 (2A+2B) is subtracted from the length L1 of the double-sided printed material, which is obtained in Step S2, thereby obtaining the length of the margins provided on the entire recording medium. Then, the length L3 of each margin produced in a case where the margins are evenly dispersed on the front and rear sides of the print information blocks 2 (2A and 2B) is calculated (Step S3e). It is judged whether the length L3 of the margin can be set within the allowable range (Step S3f). Until it is judged that the length L3 of the margin can be set within the allowable range in Step S3f, or until it is judged that the length L3 of the margin is smaller than a minimum value Min of the allowable range, Steps S3b, S3e, and S3f which include the process of additionally selecting the print information block 2 and the process of comparing the length L3 of the margin with the allowable range.

In Step S3f, when it is judged that the length L3 of the margin is smaller than the minimum value Min of the allowable range, the print information block 2 (2B) selected last from among the selected print information blocks 2 (2A and 2B) is replaced with a print information block (for example, 2D) having a shorter print length among the non-selected print information blocks 2 (Step S3h). Then, Steps S3e to S3f described above are repeated. When it is judged that the length L3 of the margin can be set within the allowable range, the print information blocks 2 (2A and 2D) are determined as the second print information, thereby ending the selection of the print information blocks 2 (Step S3g). However, in Step S3f repeatedly performed, when it is judged that the length L3 of the margin is still smaller than the minimum value Min of the allowable range, the replacement with another print information block 2 (Step S3h), the calculation of the length L3 of the margin (Step S3e), and the comparison with the allowable range and judgment thereof (Step S3f) are repeatedly performed until it is judged that the length L3 of the margin can be set within the allowable range.

Note that the above description relates to an example where a second print information block 2B additionally selected is replaced with another print information block. However, at a time point when only a first print information block 2A is selected, in Step S3f, it can be judged that the length L3 of the margin is smaller than the minimum value Min. In this case, the selected print information block 2A may be replaced with the print information block 2D having a shorter print length among the non-selected print information blocks 2 (Step S3h).

(Supplemental Explanation)

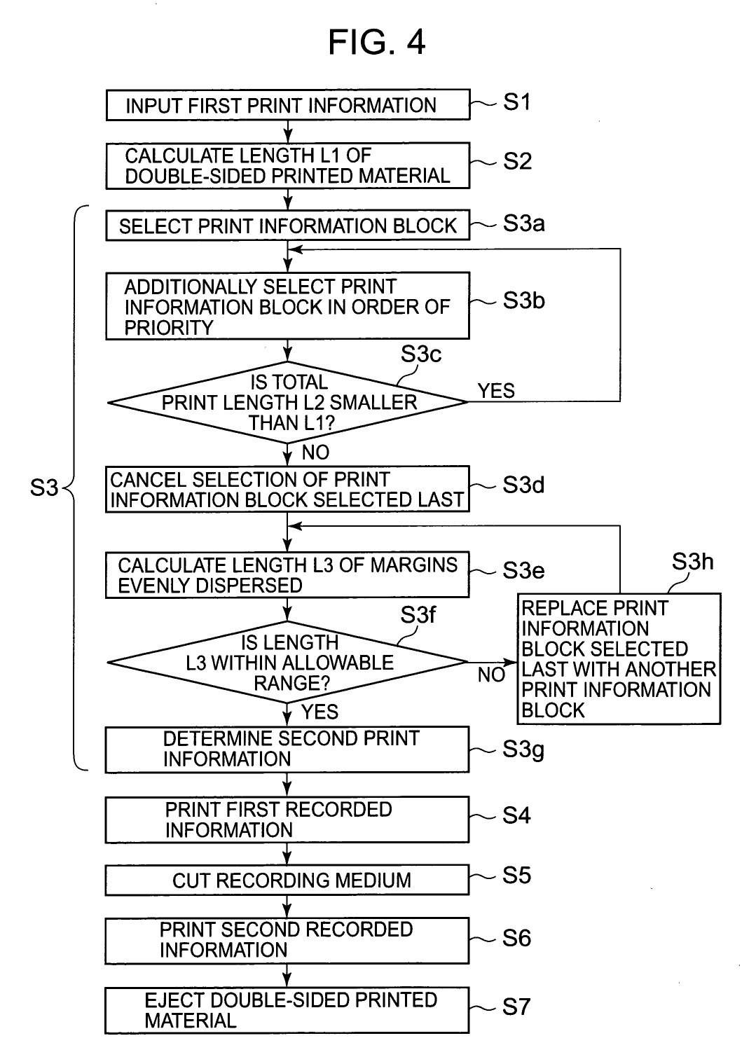

In the first and second embodiments described above, when a plurality of print information blocks stored in the memory unit 3 have various print lengths, in particular, when a print information block with an extremely short print length is included and a relatively wide allowable range for the margin is set, it is possible that an appropriate layout for the print information blocks to be printed on the back surface of the recording medium can be found in almost all cases by the method as shown in FIG. 4 or the method shown in FIG. 5. However, when there are only a small variety of print lengths of the print information blocks stored in the memory unit 3, in particular, when a print information block with a short print length does not sufficiently exist, or when the allowable range of the margin is set narrower, it is not beyond the realm of possibility that an appropriate layout for the print information block to be printed on the back surface of the recording medium is to be found by the methods shown in FIG. 4 and the method shown in FIG. 5. In this case, though not shown in the figure, for example, at a time point when the comparison with the allowable range of the margin L3 and the judgment with respect to all the print information blocks stored in the memory unit are finished, or at a time point when the number of times of replacing the print information blocks reaches the predetermined number, the printing of the second print information on the back surface of the recording medium is stopped, or the print information block in a state where the comparison with the allowable range of the margin L3 and the judgment thereof (Step S3h) are finished at last is selected and determined to be printed while the layout is inappropriate.

### Third Embodiment

In the above embodiments, the print information blocks 2 stored in the memory unit are selected in terms of only the print length and the priority. However, in this embodiment, the print information blocks 2 are selected in terms of a type (attribute) of the print information blocks 2 and variety of selecting conditions as well.

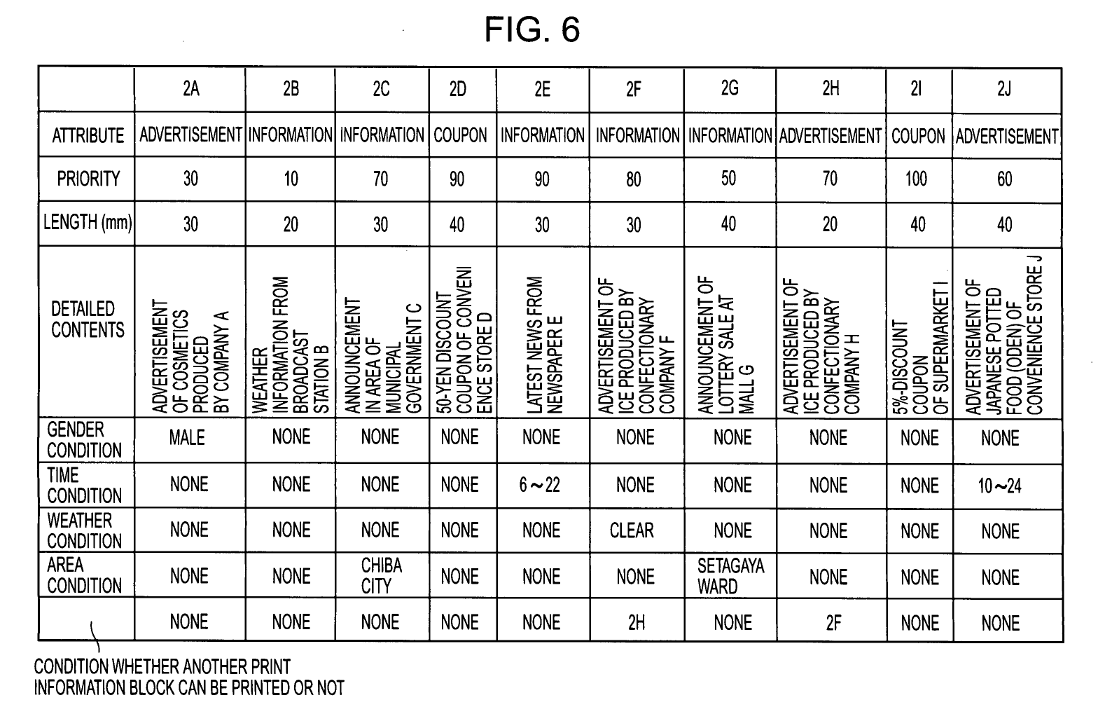

For example, as shown in FIG. 6, the respective print information blocks 2 of this embodiment include not only an advertisement but also print information blocks indicating a coupon and information for a consumer. Accordingly, those print information blocks 2 are classified into three kinds of attributes which are an advertisement, a coupon, and information. Then, the print information blocks 2 are associated with each of the attributes to be compiled as a database and stored in the memory unit 3. In addition, as selection conditions, a forbidden condition of the gender, defined conditions of time, weather, and an area, and a condition whether another specific print information block can be additionally printed or not, are stored. Those selection conditions are given if necessary, and the print information blocks with no selection conditions are blank.

Note that print information blocks 2A to 2E of the example shown in FIG. 6 are not identical with the print information blocks 2A to 2E of the example shown in FIG. 3, but are denoted by the same reference symbols for convenience.

In this embodiment, in the methods according to the first and second embodiments, control is performed based on the attributes and the selection conditions. In other words, in Step S3a of selecting the print information blocks, Step S3b of additionally selecting the print information blocks, and in Step S3h of replacing the print information block, of the methods shown in FIGS. 4 and 5, the central processing unit 5 first narrows down selection targets based on the attributes to thereby perform selection thereof. Specifically, for example, in a case where the print information blocks having various attributes are to be evenly mixed, in those steps, the selection is performed by setting, as the selection targets, only the selected print information blocks having attributes different from those of the print information blocks already selected. If the print information blocks with all kinds of the attributes have been already selected, the selection is performed by setting, as the selection target, only the print information blocks having the attribute which is different from that of the print information block selected last. As a result, it is possible to perform the control for selecting the print information blocks with the attributes being used as parameters.

Further, at a time point before executing Step S3a of selecting the first print information block, for example, when the first print information to be printed on the front surface is input from the input unit 4, the operator inputs the gender of the consumer, the whether, and the area, and a clock not shown which is attached to the central processing unit 5 inputs time. Then, the print information blocks having inappropriate selection conditions are excluded from the selection targets by the central processing unit 5. For example, when male as the gender is input from the input unit 4, the central processing unit 5 excludes the print information block 2A from the selection targets. When cloudy, rainy, or snowy as the whether is input from the input unit 4, the central processing unit 5 excludes the print information block 2F from the selection targets. When an area other than Chiba city is input from the input unit 4, the central processing unit 5 excludes the print information block 2C from the selection targets. When an area other than Setagaya ward is input from the input unit 4, the central processing unit 5 excludes the print information block 2G from the selection targets. Further, when a time between 22 o'clock and 6 o'clock is input from the clock, the central processing unit 5 excludes the print information block 2E from the selection targets. When a time between 0 o'clock and 10 o'clock is input from the clock, the central processing unit 5 excludes the print information block 2J from the selection targets.

Note that it is generally necessary to input the gender for each consumer, that is, every time a single double-sided printed material 1 is produced. However, it is sufficient that the weather condition is input only when the use of the cash register is started and when the weather condition is changed. Further, once the area is input when the cash register is installed, there is no need to input the area again thereafter.

In addition, in this embodiment, simultaneously with the refinement based on the attributes, it is confirmed whether the print information blocks (for example, 2F and 2H) incapable of being printed with another specific print information block have been already selected. If any one of those blocks (for example, 2F) has been selected, the central processing unit 5 excludes the print information block (for example, 2H) incapable of being printed with another print information block, from the selection targets. This process may be performed before or after Step S3a of selecting the print information block, Step S3b of additionally selecting the print information block, and Step S3h of replacing the print information block, of the methods shown in FIGS. 4 and 5.

In the above description, the print information blocks inappropriate for the conditions are excluded from the selection targets. Alternatively, instead of exclusion thereof from the selection targets, the priority thereof may be lowered. For example, the central processing unit 5 may perform a process for changing the priority of the print information block 2 inappropriate for the conditions to 0. In this case, only when it is necessary to perform additional selection after all the other print information blocks are selected, the print information block whose priority is changed to 0 is selected. As a matter of course, conditions for excluding the inappropriate print information blocks 2 from the selection targets, and conditions for lowering the priorities of the inappropriate print information blocks 2 may be mixed with each other.

In a case where it is desirable that the lengths of a plurality of print information blocks be set as uniform as possible, when the first print information block to be selected is determined, the priorities of all the print information blocks having the same print length as the print length of the first print information block may be set higher. The priorities may be set higher by uniformly adding 100 to the corresponding print information blocks, for example. Note that, also in this case, it is possible that, as at least the print information block to be selected last, a print information block having a different print length is selected so that the length L3 of the margin can be set within the allowable range, in the same manner as in the first and second embodiments.

Thus, the print information blocks 2 are classified based on the attributes, and the print information blocks 2 belonging to the different categories are arranged, thereby easily attracting the consumer, as compared with a case where only advertisements are arranged. When another print information block is additionally selected after the respective print information blocks 2 with various attributes are selected one by one, the print information block 2 with anyone of the attributes may be selected. However, the control is desirably performed so as to prevent the print information blocks 2 having the same attribute from being continuously selected.

Further, when various selection conditions are added to the respective print information blocks 2, it is possible to provide more detailed and effective services and advertisements.

### Fourth Embodiment

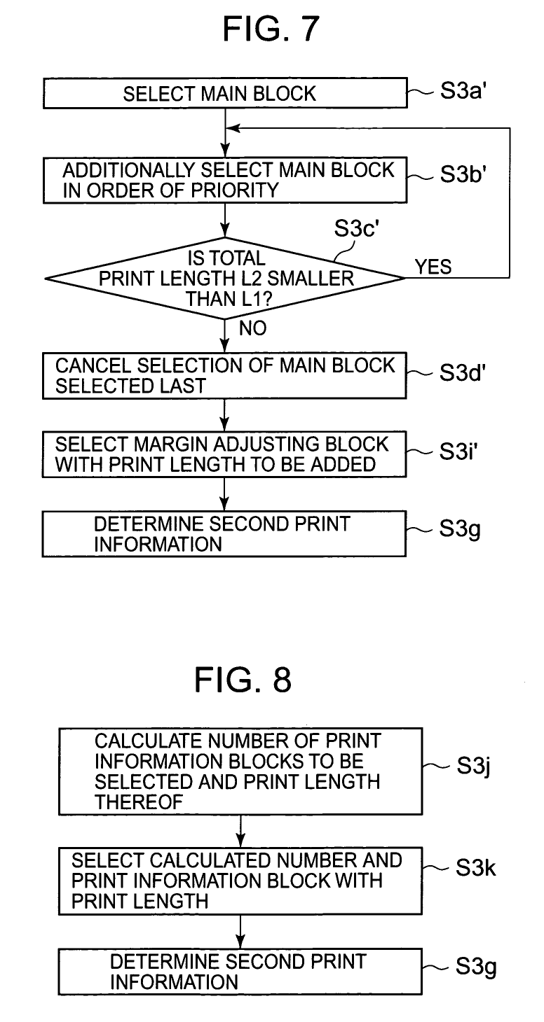

In this embodiment as shown in FIG. 7, the print information blocks 2 are classified into two kinds of main blocks 2′ and margin adjusting blocks 2″, thereby constructing two databases in the memory unit 3. As an example, the main blocks 2′ may be identical with the print information blocks 2A to 2E illustrated in FIG. 3, and may be identical with the print information blocks 2A to 2J illustrated in FIG. 6. On the other hand, the margin adjusting blocks 2″ may include greetings such as “Thank you for coming back” in addition to the advertisement, the coupon, and the information for the consumer. The margin adjusting blocks 2″ include print information blocks with a small print length which is also smaller than the minimum value Min of the allowable range of the margin S. For example, when the print length of the main block 2′ is 20 to 40 mm similarly to that of the examples shown in FIGS. 3 and 6, and the allowable range of the margin S is 3 to 5 mm, it is possible to prepare a margin adjusting block 2″ having a print length of 2 to 20 mm.

In Step S3 of selecting the print information block 2 according to this embodiment, when the main blocks 2′ of the print information blocks 2 are selected (Step S3a′) in the same manner as in the first embodiment and is additionally selected (Step S3b′), and when it is judged that the total length L2 of the print lengths is shorter than the length L1 of the double-sided printed material (Step S3c′), the selection of the last selected main block 2′ is cancelled (Step S3e′). Then, based on the total length L2 (which has been calculated before the preceding judgment step S3c′) of the main blocks 2′ which are left without canceling the selection thereof and based on the length L1 of the double-sided printed material, the print length of the margin adjusting blocks 2″, which is to be added so that the length L3 of the margins evenly dispersed can be set within the allowable range (for example, 3 to 5 mm), is calculated, thereby selecting the margin adjusting blocks 2″ having the print length from the database (Step S3i). Note that, at this time, the margin adjusting blocks 2″ are selected only based on the print length, irrespective of the contents of the information. Note that if a plurality of margin adjusting blocks 2″ having the same print length are stored, a margin adjusting blocks 2″ with a higher priority is selected. As a result, the length L3 of the margin can be set within the allowable range, thereby determining the second print information (Step S3g).

Thus, in this embodiment, among the plurality of print information blocks constituting the second print information, the main blocks 2′ are selected according to the priorities. Only a single margin adjusting block 2″ contained in the second print information is selected based on the print length. In particular, in the case where the margin adjusting block 2″ having the print length smaller than the minimum value Min of the allowable range of the margin S is contained as described above, an appropriate layout with the margin S falling within the allowable range of the margin S can be easily found.
Note that, in the above description, the margin adjusting blocks 2″ are selected after the print lengths of the margin adjusting blocks 2″ to be added are calculated. However, instead of calculating the lengths of the margin adjusting blocks 2″ in advance, the margin adjusting blocks 2″ to be added can be found by trial and error in the same manner as in Steps S3e, S3f, and S3h of the first embodiment.

Further, at a time point when the selection of the last selected main block 2′ is cancelled (Step S3e′), when the appropriate length of the margin can be obtained only by selecting the main blocks 2′ which are left without canceling the selection thereof, second recorded information may be determined without adding the margin adjusting blocks 2″.
Points other than the above-mentioned points are the same as those of the first embodiment, so descriptions thereof will be omitted.

### Fifth Embodiment

In this embodiment as shown in FIG. 8, prior to selection of the print information blocks 2, based on the length L1 of the double-sided printed material, the number of print information blocks 2 to be selected as the second recorded information and each print length thereof are calculated (Step S3j). For example, when the print information blocks 2 stored in the memory unit have three kinds of print lengths, that is, 20 mm, 25 mm, and 30 mm, respectively, the number of each of the print information blocks having the length of 20 mm, the print information blocks having the length of 25 mm, and the print information blocks having the length of 30 mm to be arranged is calculated so that the print information blocks 2 are arranged within the length L1 and the length of the margin S can be set within the allowable range. Then, by the number of blocks obtained as the calculation results, the print information blocks having each length are selected (Step S3k). In this case, when a plurality of print information blocks 2 having the same print length are stored in the memory unit 3, the print information blocks 2 having higher priority are selected.

According to this embodiment, the print information blocks 2 are selected based on the print length. However, when a plurality of print information blocks 2 having the same print length exist, the print information blocks 2 are selected according to the priorities. In the method, the print information blocks 2″ are selected by placing an emphasis on the print length, and the priority is assumed as a secondary judgment factor. Accordingly, it is more likely that the appropriate layout in which the margin S can be set within the allowable range can be found with ease and reliability.

Points other than the above-mentioned points are the same as those of the first embodiment, so descriptions thereof will be omitted.

(Structure of Double-Sided Printing Apparatus)

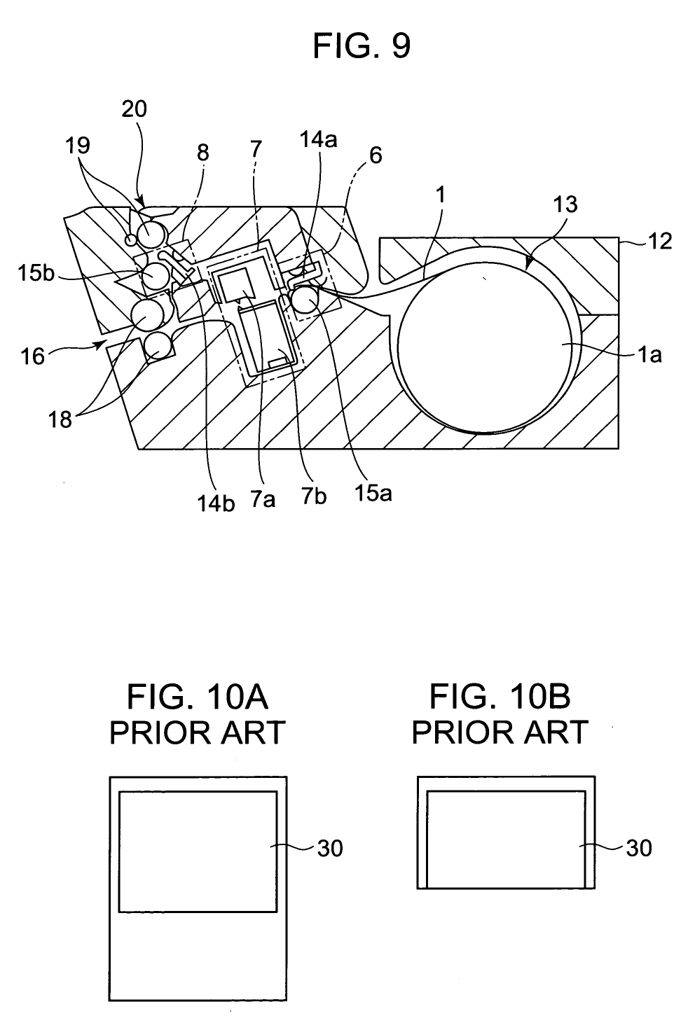

FIG. 9 schematically shows an example of a double-sided printing apparatus 11 for producing the double-sided printed material 1 by carrying out the above-mentioned method according to the present invention. The double-sided printing apparatus 11 includes a roll accommodating unit 13, the first recording unit 6, the cutter unit 7, and the second recording unit 8 which are provided in a housing 12. Note that, in the following description, a recording medium in a continuous form which is obtained before being cut into single cut sheets is also denoted by reference numeral 1.

The roll accommodating unit 13 rotatably holds a roll 1a of the recording medium 1 in a continuous form.

The first recording unit 6 includes a recording head 14a for performing printing on the recording medium 1, a platen roller 15a which is a transport mechanism to be brought into press contact with the recording head 14a. The recording head 14a of the first recording unit 6 is positioned so as to be in contact with one surface (front surface) of the recording medium 1 fed from the roll accommodating unit 13.

The cutter unit 7 is used to cut the recording medium 1 in a continuous form, one surface of which is printed by the first recording unit 6, into single cut sheets, and includes a pair of cutter members 7a and 7b, and the like. Note that the cutter members 7a and 7b are supported by a support member not shown in the figure.

The second recording unit 8 may have substantially the same structure as that of the first recording unit 6, and includes a recording head 14b for performing recording on the recording medium 1, and a platen roller 15b which is a transport mechanism to be brought into press contact with the recording head 14b. The recording heads 14a and 14b may be identical with each other, and the platen rollers 15a and 15b may be identical with each other. The second recording unit 8 is provided at a position curved from a passage for the recording medium 1 passing through the first recording unit 6 and the cutter unit 7. The recording head 14b is positioned so as to be in contact with the other surface (back surface) of the recording medium 1 which has one surface printed by the first recording unit 6 while being fed from the roll accommodating unit 13 and which is cut into single cut sheets by the cutter unit 7.

A first outlet 16 is provided at a downstream side of the cutter unit 7, and a pair of transport rollers 18 are provided between the cutter unit 7 and the first outlet 16. Accordingly, the first recording unit 6, the cutter unit 7, the pair of transport rollers 18, and the first outlet 16 are linearly arranged in a row. Further, above the second recording unit 8, there are provided a pair of delivery rollers 19 and a second outlet 20.

Description is given of the outline of the method of producing a double-sided printed material by the use of the double-sided printing apparatus 11 having the above-mentioned structure. First, the recording medium 1 in a continuous form is pulled out from the roll 1a accommodated in the roll accommodating unit 13 and is set in the first recording unit 6. Then, a recording signal is supplied to the recording head 14a so as to print the first print information on one surface of the recording medium 1 (Step S4 of FIG. 4). In synchronization with driving of the recording head 14a, the platen roller 15a is rotated, thereby transporting the recording medium 1.

The recording medium 1 in a continuous form with one surface having the first print information thus printed thereon passes between the cutter members 7a and 7b of the cutter unit 7. When a position of the recording medium 1 to be cut, that is, a position at which a margin is added on a rear side of a print end point of the first print information, reaches a position facing the cutter members 7a and 7b, the transportation of the recording medium 1 is temporarily stopped so as to cut the recording medium 1 into single cut sheets by the cutter members 7a and 7b (Step S5). After completion of the cutting, the recording medium 1 which has a recorded front surface and which has been cut into single cut sheets is further transported. After that, a leading edge of the recording medium 1 projects outside from the first outlet 16.

Before a trailing edge of the recording medium 1 escapes from the pair of transport rollers 18, the transport rollers 18 are reversely rotated. A passage for the recording medium 1 of a single cut sheet is changed, and the recording medium 1 is transported to the second recording medium 8 with the trailing edge thereof being set as a leading edge. Then, in the second recording unit 8, the recording head 14b performs printing on the back surface of the recording medium 1 (Step S6). At the same time, the platen roller 15b and the delivery rollers 19 are rotated, thereby delivering the double-sided printed material 1 of a single cut sheet to the outside from the second outlet 20 (Step S7).

The double-sided printing apparatus 11 is attached with control units such as the central processing unit 5, the memory unit 3, and the input unit 4 shown in FIG. 2. Various rollers, heads, and cutter units are controlled by the central processing unit. In addition, with the double-sided printing apparatus, the first and second recording information determined by methods as shown in FIGS. 4 and 5 are printed, thereby making it possible to produce a satisfactory double-sided printed material.

What is claimed is:

1. A method of producing a double-sided printed material of a single cut sheet, comprising the steps of:
printing first print information on one surface of a recording medium in a continuous form,
the first print information comprising information which may have a different print length for each double-sided printed material;
cutting a portion of the recording medium, on which the first print information is printed; and
printing second print information on the other surface of the recording medium,
the second print information comprising one or a plurality of print information blocks selected from among a plurality of print information blocks which are independent of each other and are stored in a memory unit in advance,
the print information blocks each having, as data, a print length required when the print information blocks are each printed on the recording medium, and priorities of information contents, and being compiled as a database and stored; and
selecting, by a central processing unit, the print information blocks constituting the second print information before printing is performed on the other surface of the recording medium,
wherein the step of selecting the print information blocks comprises:
selecting the print information blocks according to the priorities thereof; and
selecting, by the central processing unit, one of the print information blocks in such a manner that a print length of the first print information is obtained, a length of the double-sided printed material is obtained based on the print length, and a plurality of margins provided on the other surface are evenly dispersed based on the obtained print length of the double-sided printed material so as to be set within an allowable range determined in advance.

2. A method of producing a double-sided printed material according to claim 1, wherein
the step of selecting, by the central processing unit, the print information blocks comprises the steps of:
repeatedly selecting the print information blocks in an order of higher priority among non-selected print information blocks;
judging whether the selected print information blocks can be arranged on the double-sided printed material, and canceling selection of one of the print information blocks when it is judged that the selected print information blocks cannot be arranged therein;
judging whether lengths of margins evenly dispersed are set within the allowable range in a case where margins in a direction of the print length, which are produced when the print information blocks that are left without canceling selection thereof are arranged within the double-sided printed material, are evenly dispersed on front and rear sides of the print information blocks; and
replacing one of the print information blocks, which are left without canceling selection thereof, with the print information block having a print length different from that of the one of the print information blocks, when it is judged that the length of the margins is not set within the allowable range.

3. A method of producing a double-sided printed material according to claim 2, further comprising the steps of:
replacing a single print information block selected last among the print information blocks, which are left without canceling selection thereof, with the print information block having a print length shorter than that of the last selected print information block, when it is judged that the length of the margins is smaller than a minimum value of the allowable range; and
replacing a single print information block selected last among the print information blocks, which are left without canceling selection thereof, with the print information block having a print length longer than that of the last selected print information block, when it is judged that the length of the margins is larger than a maximum value of the allowable range.

4. A method of producing a double-sided printed material according to claim 1, wherein
the step of selecting, by the central processing unit, the print information block comprises the steps of:
selecting the print information blocks in an order of higher priority among non-selected print information blocks;
judging whether a length of each of margins evenly dispersed can be set within the allowable range, in a case where the margins in a direction of the print length, which are produced when the selected print information blocks are arranged within the double-sided printed material, are evenly dispersed on front and read sides of the print information blocks;
when it is judged that the length of the margins cannot be set within the allowable range, replacing one of the selected print information blocks with the print information block having a print length different from that of the one of the selected information blocks, or additionally selecting any one of the non-selected print information blocks.

5. A method of producing a double-sided printed material according to claim 4, further comprising the steps of:
when it is judged that the length of the margins is smaller than a minimum value of the allowable range, replacing one of the selected print information blocks with the print information block having a print length shorter than that of the one of the selected print information blocks; and
when it is judged that the length of the margins is larger than a maximum value of the allowable range, additionally selecting any one of the non-selected print information blocks.

6. A method of producing a double-sided printed material according to claim 2, further comprising the steps of:
when it is judged that the length of the margins cannot be set within the allowable range, repeatedly performing replacement of one of the selected print information blocks with the print information block having the print length different from that of the one of the selected print information block, or additional selection of any one of the non-selected print information blocks; and
when it is judged that the length of the margins can be set within the allowable range, when judgment whether or not the margin can be set within the allowable range is completed with respect to all the stored print information blocks, or when the number of times of repeating the replacement of the print information block or the additional selection reaches a predetermined number of times, repetition of the replacement of the print information block or the additional selection is finished.

7. A method of producing a double-sided printed material according to claim 1, wherein:
the print information blocks each have a parameter of a selection condition, in addition to the print length and the priority; and
the parameter indicates a type of information of each of the print information blocks, and the print information blocks of different types from each other are preferentially selected in a case of selecting a plurality of the print information blocks.

8. A method of producing a double-sided printed material according to claim 1,
wherein the print information blocks each have a parameter of a selection condition, in addition to the print length and the priority, and the print information blocks can be selected only when the selection condition is satisfied.

9. A method of producing a double-sided printed material of a single cut sheet, comprising the steps of:
printing first print information on one surface of a recording medium in a continuous form,
the first print information comprising information which may have a different print length for each double-sided printed material;
cutting a portion of the recording medium, on which the first print information is printed; and
printing second print information on the other surface of the recording medium,
the second print information comprising one or a plurality of print information blocks selected from among a plurality of print information blocks which are independent of each other and are stored in a memory unit in advance,
the print information blocks comprising: a plurality of main blocks, each of which includes, as data, a print length required when the print information blocks are each printed on the recording medium, and priorities of information contents, and which are compiled as a database and stored in the memory unit; and a plurality of margin adjusting blocks, each of which has, as data, the print length required when the print information blocks are printed on the recording medium, and which are stored in the memory unit as another database separate from the main blocks,
the another database storing the plurality of margin adjusting blocks having different print lengths including print information blocks having the print length shorter than that of the main blocks; and
selecting, by a central processing unit, the print information blocks constituting the second print information before printing is performed on the other surface of the recording medium,
wherein the step of selecting the print information blocks comprises the steps of:
selecting at least one of the margin adjusting blocks;
selecting one or a plurality of the main blocks as well as the at least one of the margin adjusting blocks according to the priorities; and
selecting, by the central processing unit, the at least one of the margin adjusting blocks based on the print length in such a manner that a print length of the first print information is obtained, a length of the double-sided printed material is obtained based on the print length, and a plurality of margins provided on the other surface are evenly dispersed based on the obtained length of the double-sided printed material so as to be set within an allowable range determined in advance.

10. A method of producing a double-sided printed material of a single cut sheet, comprising the steps of:
printing first print information on one surface of a recording medium in a continuous form,
the first print information comprising information which may have a different print length for each double-sided printed material;
cutting a portion of the recording medium, on which the first print information is printed;
printing second print information on the other surface of the recording medium,
the second print information comprising one or a plurality of print information blocks selected from among a plurality of print information blocks which are independent of each other and are stored in a memory unit in advance,
the print information blocks each having, as data, a print length required when the print information blocks are each printed on the recording medium, and priorities of information contents, and being compiled as a database and stored;
the print information blocks being given the priorities different from each other, in a case where a plurality of the print information blocks having the same print length are stored in the memory unit; and
selecting, by a central processing unit, the print information blocks constituting the second print information before printing is performed on the other surface of the recording medium,
wherein,
the step of selecting the print information blocks comprises determining, by the central processing unit, the print length of one or a plurality of the print information blocks to be selected, in such a manner that a print length of the first print information is obtained, a length of the double-sided printed material is obtained based on the print length, and a plurality of margins provided on the other surface are evenly dispersed based on the obtained length of the double-sided printed material so as to be set within an allowable range determined in advance, to thereby select the print information blocks with higher priority among the print information blocks having the determined print length.

11. A double-sided printing apparatus, comprising:
a first recording unit for printing first print information on one surface of a recording medium in a continuous form,
the first print information comprising information which may have a different print length for each double-sided printed material;
a cutter unit for cutting a portion of the recording medium, on which the first print information is printed;
a second recording unit for printing second print information on the other surface of the recording medium,
the second print information comprises one or a plurality of print information blocks selected from among a plurality of print information blocks which are independent of each other and are stored in a memory unit in advance;
a memory unit for causing the print information blocks each to hold, as data, a print length required when the print information blocks are each printed on the recording medium, and priorities of information contents, so as to be compiled as a database and stored; and
a central processing unit for selecting the print information blocks constituting the second print information before printing is performed on the other surface of the recording medium, the central processing unit selecting the print information blocks according to the priorities thereof, and selecting one of the print information blocks in such a manner that a print length of the first print information is obtained, a length of the double-sided printed material is obtained based on the print length, and a plurality of margins provided on the other surface are evenly dispersed based on the obtained print length of the double-sided printed material so as to be set within an allowable range determined in advance.

12. A double-sided printing apparatus, comprising:
a first recording unit for printing first print information on one surface of a recording medium in a continuous form,
the first print information comprising information which may have a different print length for each double-sided printed material;
a cutter unit for cutting a portion of the recording medium, on which the first print information is printed;
a second recording unit for printing second print information on the other surface of the recording medium,
the second print information comprising one or a plurality of print information blocks selected from among a plurality of print information blocks which are independent of each other and are stored in a memory unit in advance;
a memory unit for separating the print information blocks into a plurality of main blocks and into a plurality of margin adjusting blocks which include print information blocks having the print length shorter than that of the main blocks and which have different print lengths, causing the main blocks to each hold, as data, a print length required when the print information blocks are each printed on the recording medium, and priorities of information contents, so as to be complied as a database and stored, and for causing the plurality of margin adjusting blocks to each hold, as data, a print length required when the print information blocks are each printed on the recording medium, so as to be stored as another database separate from the main blocks; and
a central processing unit for selecting the print information blocks constituting the second print information before printing is performed on the other surface of the recording medium,
wherein the central processing unit selects at least one of the margin adjusting blocks in a case of selecting the information print blocks, and selects the main blocks according to the priorities in a case of selecting one or a plurality of main blocks in addition to the at least one of the margin adjusting block, and
the central processing unit selects the at least one of the margin adjusting blocks based on the print length in such a manner that a print length of the first print information is obtained, a length of the double-sided printed material is obtained based on the print length, and a plurality of margins provided on the other surface are evenly dispersed based on the obtained length of the double-sided printed material so as to be set within an allowable range determined in advance.

13. A double-sided printing apparatus, comprising:
a first recording unit for printing first print information on one surface of a recording medium in a continuous form,
the first print information comprising information which may have a different print length for each double-sided printed material;
a cutter unit for cutting a portion of the recording medium, on which the first print information is printed;
a second recording unit for printing second print information on the other surface of the recording medium,
the second print information comprising one or a plurality of print information blocks selected from among a plurality of print information blocks which are independent of each other and are stored in a memory unit in advance;
a memory unit for causing the print information blocks to each hold a print length required when the print information blocks are each printed on the recording medium, and priorities of information contents, as data, so as to be complied as a database and stored, and for causing the print information blocks to each hold the priorities different from each other to be stored when the print information blocks having the same print length exist; and
a central processing unit for selecting the print information blocks constituting the second print information before printing is performed on the other surface of the recording medium, determining the print length of one or a plurality of the print information blocks to be selected, in such a manner that a print length of the first print information is obtained, a length of the double-sided printed material is obtained based on the print length, and a plurality of margins provided on the other surface are evenly dispersed based on the obtained length of the double-sided printed material so as to be set within an allowable range determined in advance, to thereby select the print information blocks with higher priorities among the print information blocks having the determined print length.
